(19) United States
(12) Patent Application Publication
(10) Pub. No.: US 2026/0269492 A1
(43) Pub. Date: Sep. 10, 2026

(54) WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yoshitaka YAMADA, Mie (JP); Hayato OOI, Mie (JP); Toyoki FURUKAWA, Mie (JP)

(21) Appl. No.: 19/167,846

(22) PCT Filed: Mar. 26, 2024
(86) PCT No.: PCT/JP2024/011931

§ 371 Date: Sep. 23, 2025

(30) Foreign Application Priority Data
Mar. 30, 2023 (JP) 2023-054682

(51) Int. Cl. H01R 11/11; H01B 7/00; H01B 7/02; H01B 17/66

(52) U.S. Cl. CPC H01R 11/11; H01B 7/0045; H01B 7/02; H01B 17/66

(57) ABSTRACT

A wire harness includes: an insulated wire including a conductor and an insulation coating that covers an outer circumference of the conductor; and an additional member including a wire accommodation part, wherein the insulated wire has a large-diameter portion and a small-diameter portion along an axial direction, the small-diameter portion having an outer diameter smaller than an outer diameter of the large-diameter portion, the wire accommodation part of the additional member is not capable of accommodating the large-diameter portion but is capable of accommodating the small-diameter portion, and the additional member is attached to the insulated wire with the small-diameter portion of the insulated wire being accommodated in the wire accommodation part.

### TECHNICAL FIELD

The present disclosure relates to a wire harness.

### BACKGROUND

Insulated wires are used for electrical connections within and between electrical/electronic devices, and these insulated wires are often used with electrical connection members such as connectors attached to them. In devices and the like installed in automobiles, miniaturization of electrical connection members such as connectors is in progress, but in order to miniaturize the electrical connection members, it is often necessary to also reduce the dimensions of a portion of the electrical connection member that accommodates the insulated wire. In this case, in order to accommodate the insulated wire in an accommodation portion whose dimension is reduced without applying any unreasonable load to the insulated wire, it is necessary to reduce the outer diameter of the insulated wire. For example, a wire harness with a connector attached to an end portion of an insulated wire may have a configuration in which a wire insertion hole is provided in an end face of a connector housing that constitutes the connector and the connector housing is fixed to the insulated wire with the insulated wire inserted into the wire insertion hole. In this configuration, if the diameter of the wire insertion hole is also reduced to miniaturize the connector housing, it will be necessary to set the outer diameter of the insulated wire to be not greater than the inner diameter of the wire insertion hole in order to insert the insulated wire into the wire insertion hole without applying any unreasonable load to the insulated wire. Thus, as a means for reducing the diameter of an insulated wire according to the dimension of a wire accommodation portion of an electrical connection member such as a connector, Patent Document 1 discloses a method of limiting the cross-sectional area of a conductor or the thickness of an insulation coating to a predetermined upper limit or less, in addition to devising a twisted structure of the bare wires of the conductor.

### PRIOR ART DOCUMENT

### Patent Document

Patent Document 1: JP 2022-123089 A

### SUMMARY OF THE INVENTION

### Problems to be Solved

If, as described above, the cross-sectional area of a conductor or the thickness of an insulation coating is reduced in order to reduce the diameter of an insulated wire to miniaturize an electrical connection member such as a connector, the characteristics of the insulated wire may be affected. For example, if the insulation coating is thinned, the protective performance of the insulation coating of the insulated wire may be reduced. This gives rise to the need for taking measures such as placing an exterior material with high protective performance around the outer circumference of the insulated wire to compensate for the protective performance of the insulation coating. There is a demand for a technique that allows a miniaturized electrical connection member to be attached to an insulated wire while minimizing the effect on the characteristics of the insulated wire as much as possible.

In view of the above, an object is to provide a wire harness that allows a small electrical connection member to be attached to an insulated wire while minimizing the effect on the characteristics of the insulated wire.

### Means to Solve the Problem

A wire harness of the present disclosure includes: an insulated wire including a conductor and an insulation coating that covers an outer circumference of the conductor; and an additional member including a wire accommodation part, wherein the insulated wire has a large-diameter portion and a small-diameter portion along an axial direction, the small-diameter portion having an outer diameter smaller than an outer diameter of the large-diameter portion, the wire accommodation part of the additional member is not capable of accommodating the large-diameter portion but is capable of accommodating the small-diameter portion, and the additional member is attached to the insulated wire with the small-diameter portion of the insulated wire being accommodated in the wire accommodation part.

### Effect of the Invention

The wire harness of the present disclosure is a wire harness that allows a small electrical connection member to be attached to an insulated wire while minimizing the effect on the characteristics of the insulated wire.

### BRIEF DESCRIPTION OF THE DRAWINGS

FIG. 1 is a partial cross-sectional view showing a wire harness according to an embodiment of the present disclosure.

FIGS. 2A and 2B are a perspective view and a side view, respectively, showing an insulated wire that constitutes the wire harness. FIG. 2B also shows the dimensional relationship with a wire insertion hole in the wire harness.

FIG. 3 is a picture of a longitudinal cross section of a model sample simulating the wiring harness.

### DETAILED DESCRIPTION TO EXECUTE THE INVENTION

### Description of Embodiments of Present Disclosure

First, embodiments of the present disclosure will be listed and described. A wire harness according to the present disclosure includes the following configuration.

[1] A wire harness of the present disclosure includes: an insulated wire including a conductor and an insulation coating that covers an outer circumference of the conductor; and an additional member including a wire accommodation part, wherein the insulated wire has a large-diameter portion and a small-diameter portion along an axial direction, the small-diameter portion having an outer diameter smaller than an outer diameter of the large-diameter portion, the wire accommodation part of the additional member is not capable of accommodating the large-diameter portion but is capable of accommodating the small-diameter portion, and the additional member is attached to the insulated wire with the small-diameter portion of the insulated wire being accommodated in the wire accommodation part.

The insulated wire constituting the wire harness has the small-diameter portion and the large-diameter portion. In the additional member attached to the insulated wire, the wire accommodation part is not capable of accommodating the large-diameter portion of the insulated wire but is capable of accommodating the small-diameter portion. In this way, even if the additional member is small so that the large-diameter portion cannot be accommodated in the wire accommodation part, the wire accommodation part accommodates the small-diameter portion of the insulated wire, so the additional member can be attached to the insulated wire without applying a large load, such as compression of the insulation coating, to the insulated wire. At this time, it is sufficient that the small-diameter portion of the insulated wire be formed only in a portion necessary for accommodation in the wire accommodation part of the additional member, and other portions be defined as the large-diameter portion. In the large-diameter portion, the wire outer diameter does not need to be reduced to match the miniaturization of the additional member, so the cross-sectional area of the conductor and the thickness of the insulation coating can be sufficiently secured, and the diameter reduction does not affect the characteristics of the insulated wire over the entire region except for the small-diameter portion. The insulated wire having the small-diameter portion in a partial region in the axial direction can be easily formed by appropriately heating the insulated wire with a uniform outer diameter only at a position that serves as the small-diameter portion and compressing it using press molding or the like. In this case, in the small-diameter portion, not only the outer diameter but also the variation in outer diameter is reduced, so the dimension margin to be provided in the wire accommodation part of the additional member taking into account the variation in the wire outer diameter can be kept small. This also contributes to forming a small wire accommodation part.

[2] In the mode of [1] above, preferably, the wire accommodation part of the additional member is formed as a through hole having an inner diameter that is larger than the outer diameter of the small-diameter portion of the insulated wire and smaller than the outer diameter of the large-diameter portion, and the small-diameter portion of the insulated wire is inserted into the wire accommodation part. In this case, if, in the additional member, the insulated wire is inserted, from its portion where the small-diameter portion is provided, into the wire accommodation part provided as a through hole, the large-diameter portion cannot pass through the through hole, but the small-diameter portion can pass through the through hole without being subjected to an unreasonable load. If the additional member is attached to the insulated wire with the small-diameter portion passing through the through hole in this manner, the additional member can be attached to the insulated wire at a predetermined position without any difficulty, even if the additional member is miniaturized.

[3] In the mode according to [1] or [2] above, preferably, the insulated wire has the small-diameter portion at its end portion in the axial direction, and the additional member is a connector. A connector housing constituting the connector may be provided with the wire accommodation part, such as the through hole according to the mode of [2] above, so as to be coupled to the insulated wire in a predetermined positional relationship. If the wire accommodation part is configured with dimensions that do not allow the large-diameter portion to be accommodated but allow the small-diameter portion to be accommodated, even a small connector that cannot be attached to an insulated wire having the same outer diameter as the large-diameter portion can be attached to the insulated wire using the small-diameter portion.

[4] In the mode according to [1] or [3] above, preferably, at least one of an outer diameter of the conductor and a thickness of the insulation coating is smaller in the small-diameter portion than in the large-diameter portion. Making at least one of the outer diameter of the conductor and the thickness of the insulation coating smaller in the small-diameter portion can effectively reduce the outer diameter of the insulated wire as a whole.

[5] In the mode according to [4] above, preferably, both the outer diameter of the conductor and the thickness of the insulation coating are smaller in the small-diameter portion than in the large-diameter portion. In this case, a particularly high effect on the reduction in the outer diameter of the small-diameter portion can be achieved. As described above, when forming the small-diameter portion by press molding, reductions in both the outer diameter of the conductor and the thickness of the insulation coating are likely to occur. In particular, a reduction in the thickness of the insulation coating is achieved effectively.

[6] In the mode according to any one of [1] to [5] above, preferably, the outer diameter of the small-diameter portion is at least 3% smaller than the outer diameter of the large-diameter portion. In this case, a sufficient effect on miniaturization of the wire accommodation part and the additional member accompanied by the reduction in the outer diameter of the small-diameter portion can be achieved. The reduction in the outer diameter by at least 3% can be achieved by press molding, for example.

[7] In the mode according to any one of [1] to [6] above, preferably, a thickness of the insulation coating in the small-diameter portion is at least 10% smaller than a thickness of the insulation coating in the large-diameter portion. In this case, the reduction in the thickness of the insulation coating can have a sufficient effect on the reduction in the outer diameter of the insulated wire as a whole, accompanied by the miniaturization of the wire accommodation part and the additional member. The reduction in the thickness of the insulation coating by at least 10% can be achieved by press molding, for example.

[8] In the mode according to any one of [1] to [7] above, preferably, a variation in thickness of the insulation coating is smaller in the small-diameter portion than in the large-diameter portion. In the small-diameter portion, a small variation in the thickness of the insulation coating results in a small variation in the outer diameter of the insulated wire. Accordingly, the margin to be provided in the dimensions of the wire accommodation part of the additional member, taking into account the variation in the outer diameter of the insulated wire will be small, which is highly effective for miniaturization of the additional member. When forming the small-diameter portion by press molding, it is easy to reduce the variation in the thickness of the insulation coating.

### Detail of Embodiments of Present Disclosure

Hereinafter, a wire harness according to an embodiment of the present disclosure will be described in detail with reference to the drawings. The wire harness according to the embodiment of the present disclosure includes an insulated wire and an additional member such as a connector attached to the insulated wire. In the present specification, with respect to the shape and structure of each member of the wire harness, concepts such as the shapes of members, e.g. “straight line” and “circle”, and their arrangement may include deviations from the strict geometric concept to an extent that is permissible in this type of wire harness, e.g. up to approximately ±15% in length and approximately ±15° in angle.

### <Configuration of Wire Harness>

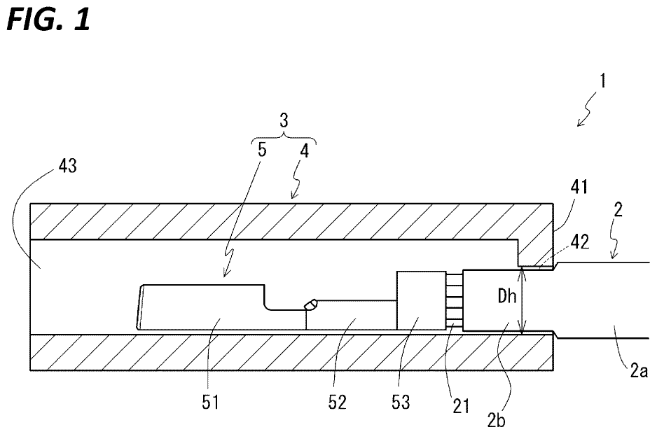

First, the configuration of the wire harness according to an embodiment of the present disclosure will be described. FIG. 1 shows the configuration of a wire harness 1 according to the embodiment of the present disclosure in a partial cross-sectional view. The wire harness 1 includes an insulated wire 2, and a connector 3 serving as an additional member.

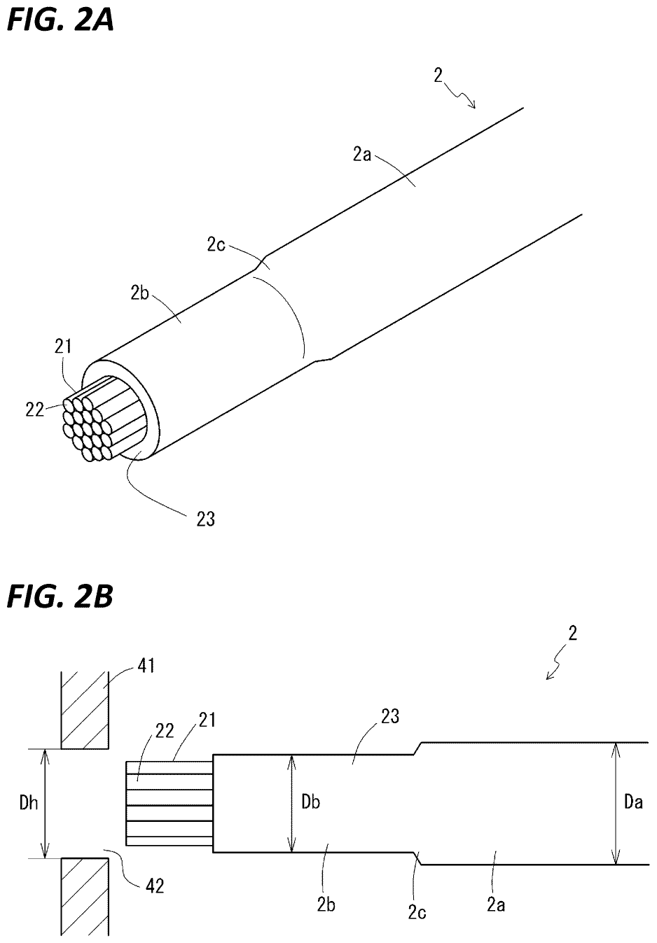

The insulated wire 2 constituting the wire harness 1 is shown in a perspective view of FIG. 2A and in a side view of FIG. 2B. The insulated wire 2 includes a conductor 21, and an insulation coating 23 that covers the outer circumference of the conductor 21. In FIGS. 2A and 2B, the insulation coating 23 is shown partially removed at its end.

The insulated wire 2 has a large-diameter portion 2a and a small-diameter portion 2b along its axial direction (longitudinal direction). The small-diameter portion 2b has an outer diameter smaller than that of the large-diameter portion 2a. In the present embodiment, the small-diameter portion 2b is formed at an end portion of the insulated wire 2. The configuration of the insulated wire 2 will be described in detail later.

The connector 3 includes a connector terminal 5 and a connector housing 4. The connector terminal 5 is an electrical connection member capable of forming an electrical connection with a counterpart conductive member and is connected and fixed to an end of the insulated wire 2. The type and shape of the connector terminal 5 are not particularly limited, but in the form shown in the figure, the connector terminal 5 is a female terminal of a mating type. Here, the connector terminal 5 has a connection 51 on its leading end side. The connector terminal 5 also has a clamping portion that is formed in one piece with the rear end of the connection 51 while extending therefrom, and consists of a first clamping portion 52 and a second clamping portion 53. The connection 51 is configured as a box-shaped mating connection of a female mating terminal and can mate with a male terminal (not shown) to form an electrical connection.

In the wire harness 1, the insulation coating 23 is removed in a partial region on the leading end side in the small-diameter portion 2b provided at an end portion of the insulated wire 2, and the conductor 21 is exposed. The end portion of the insulated wire 2 in which the conductor 21 is exposed is clamped and fixed by the clamping portions 52 and 53 of the connector terminal 5, so that the insulated wire 2 and the connector terminal 5 are connected to each other. Specifically, the first clamping portion 52 electrically connects the conductor 21 to the connector terminal 5, and physically fixes the conductor 21 to the connector terminal 5. On the other hand, the second clamping portion 53, behind the first clamping portion 52, fixes the insulated wire 2 with a force weaker than that with which the first clamping portion 52 fixes the conductor 21, and assists in physically fixing the insulated wire 2 to the connector terminal 5. The second clamping portion 53 may clamp and fix the conductor 21 exposed at the end of the insulated wire 2 at a rearward position as shown in the figure, or may clamp and fix the insulated wire 2 from the outer circumference of the insulation coating 23 at a further rearward position where the conductor 21 is covered by the insulation coating 23.

In the connector 3, the connector terminal 5 coupled to the leading end of the insulated wire 2 is housed in the connector housing 4. The connector housing 4 is configured as a hollow box-shaped member with openings at the front and rear ends. A wire insertion hole 42, serving as a wire accommodation part, is provided in a rear end wall 41 of the connector housing 4. The wire insertion hole 42 is provided in the form of a through hole passing through the plate-shaped rear end wall 41. As shown in FIGS. 1 and 2B, the wire insertion hole 42 has an inner diameter Dh that is larger than an outer diameter Db of the small-diameter portion 2b of the insulated wire 2 and smaller than an outer diameter Da of the large-diameter portion 2a (Db<Dh<Da). The wire insertion hole 42 is preferably provided as a circular through hole.

As a result of the wire insertion hole 42 having the inner diameter Dh that is larger than the outer diameter Db of the small-diameter portion 2b and smaller than the outer diameter Da of the large-diameter portion 2a, the small-diameter portion 2b of the insulated wire 2 can be inserted into (accommodated in) and passed through the wire insertion hole 42 without being deformed by the compression of the insulation coating 23 or the like. On the other hand, the large-diameter portion 2a of the insulated wire 2 cannot be inserted into (accommodated in) and passed through the wire insertion hole 42 without being deformed. In fact, as shown in FIG. 1, in the wire harness 1, the small-diameter portion 2b of the insulated wire 2 to which the connector terminal 5 is connected is inserted into the wire insertion hole 42 from the outside of the connector housing 4, and is passed through the wire insertion hole 42. On the other hand, the large-diameter portion 2a cannot enter the wire insertion hole 42, and the entire area of the large-diameter portion 2a remains outside the connector housing 4.

The connector housing 4 also has, at the front end thereof, a mating port 43 as an opening that a counterpart male connector (not shown) can enter. A male terminal of the male connector having entered the mating port 43 can be mated and connected with the female connector terminal 5.

In the shown form, the dimension of the cross section of the connector terminal 5 orthogonal to the axial direction is smaller than the dimension of the cross section of the small-diameter portion 2b of the insulated wire 2. Therefore, by connecting the connector terminal 5 to the end of the insulated wire 2 and then inserting the connector terminal 5 into the wire insertion hole 42 from the rear, it is possible to configure a wiring harness 1 in which the connector terminal 5 connected to the insulated wire 2 is housed in the connector housing 4. Typically, a positioning member (not shown) is provided inside the connector housing 4 to stably place the connector terminal 5 in a predetermined position, but the boundary between the small-diameter portion 2b and the large-diameter portion 2a of the insulated wire 2 also supplementarily functions as a positioning member for preventing the insulated wire 2 from further advancing forward. The connector housing 4 may be configured with a halvable structure such that it can be split into the upper and lower sections as shown in the figure. In this case, even when the dimension of the cross section of the connector terminal 5 is larger than the dimension of the cross section of the insulated wire 2, the connector terminal 5 connected to the leading end of the insulated wire 2 can be easily housed in the connector housing 4 and the wire harness 1 can be assembled.

Thus, in the wire harness 1 according to the present embodiment, the insulated wire 2 that constitutes the wire harness 1 has a large-diameter portion 2a whose outer diameter Da is larger than the inner diameter Dh of the wire insertion hole 42 of the connector housing 4, but has a small-diameter portion 2b whose outer diameter Db is larger than the inner diameter Dh of the wire insertion hole 42, thus making it possible to attach the connector housing 4 to the insulated wire 2 with the small-diameter portion 2b inserted into the wire insertion hole 42 of the connector housing 4. If an insulated wire does not have such a small-diameter portion 2b and the entire region of the insulated wire is configured as a large-diameter portion 2a with a large outer diameter Da, the same connector 3 cannot be attached to the insulated wire. In recent years, there has been a demand for miniaturization of electrical connection members such as connectors, and if connectors are miniaturized, the diameter of a wire insertion hole formed in the connector housing will also be reduced accordingly. However, in the wire harness 1 according to the present embodiment, the insulated wire 2 is provided with the small-diameter portion 2b, so even a small connector 3 with only a small wire insertion hole 42 can be attached to the insulated wire 2 by using the small-diameter portion 2b. Although, typically, a compatible connector is manufactured in accordance with the standard dimension of the outer diameter of an insulated wire, a connector 3 that corresponds to a standard insulated wire with a smaller diameter compared to an insulated wire with the same outer diameter Da as that of the large-diameter portion 2a can be attached to the insulated wire 2 without difficulty by using the small-diameter portion 2b.

Conventionally, a method of forming a thinner insulation coating was sometimes used to connect a connector with a standard smaller than a typical one to an insulated wire, but in such cases, due to the thinner insulation coating, the properties that should be exhibited by the insulation coating, such as the protective performance against the conductor, may not be fully obtained. However, in the wire harness 1 according to the present embodiment, the greater part of the insulated wire 2 is the large-diameter portion 2a, and by configuring the insulated wire 2 with a dimension that can realize the required characteristics such as the protective performance of the insulation coating 23 in the large-diameter portion 2a, and providing the small-diameter portion 2b only at the end portion to which the connector 3 is attached, it is possible to attach the small connector 3 to the insulated wire 2 while limiting the effect of the diameter reduction on the characteristics to only the small-diameter portion 2b. To attach the connector 3, there is no need to forcibly compress and press-fit the insulation coating of a large-diameter insulated wire to fit the insulated wire into the wire insertion hole 42. As will be described later regarding an insulated wire manufacturing method, the insulated wire 2 having both the large-diameter portion 2a and the small-diameter portion 2b can be easily manufactured by using a typical conventional insulated wire that has an outer diameter Da corresponding to that of the large-diameter portion 2a over the entire area, and forming a small-diameter portion 2b at a desired position.

In the above-described wire harness 1, the connector 3 that includes the connector housing 4 with the wire insertion hole 42 serving as a wire accommodation part is attached, as an additional member, to the end portion of the insulated wire 2, but the additional member is not limited to this connector 3. It is sufficient if the additional member has a wire accommodation part, and the wire accommodation part is not capable of accommodating the large-diameter portion 2a of the insulated wire 2 but is capable of accommodating the small-diameter portion 2b of the insulated wire 2. Here, the expression “the wire accommodation part is not capable of accommodating the large-diameter portion 2a” means that the large-diameter portion 2a cannot be accommodated without being deformed, and the expression “the wire accommodation part is capable of accommodating the small-diameter portion 2b” means that the small-diameter portion 2b can be accommodated without being deformed. Note that, when the small-diameter portion 2b is accommodated in the wire accommodation part, the present invention does not preclude a case where the small-diameter portion 2b is temporarily deformed during the accommodation operation, as long as the small-diameter portion 2b can be accommodated in the wire accommodation part without being deformed after the completion of the operation. Although it is preferable that the small-diameter portion 2b actually accommodated in the wire accommodation part is not deformed, the small-diameter portion 2b actually accommodated in the wire accommodation part may have some deformation, as long as the small-diameter portion 2b can be accommodated in the wire accommodation part without being deformed in terms of the shape and dimension relationship between the small-diameter portion 2b and the wire accommodation part.

As described above, the additional member having a wire accommodation part that is not capable of accommodating the large-diameter portion 2a of the insulated wire 2 but is capable of accommodating the small-diameter portion 2b is attached to the insulated wire 2 with the small-diameter portion 2b of the insulated wire 2 being accommodated in the wire accommodation part, thereby constituting the wire harness. Accordingly, the small-diameter portion 2b can be used to attach, to the insulated wire 2, a small additional member that cannot be attached to an insulated wire having the same outer diameter as that of the large-diameter portion 2a, thereby eliminating the need of forming the insulated wire 2 as a whole with the same outer diameter as that of the small-diameter portion 2b. In this case, the large-diameter portion 2a need only be configured as a portion having an outer diameter large enough to exhibit the desired characteristics, and thus it is possible to attach a small electrical connection member to the insulated wire 2 while minimizing the effect on the characteristics of the insulated wire 2. The position of the insulated wire 2 at which the small-diameter portion 2b is provided is also not limited to the end portion, as in the wire harness 1 according to the above-described embodiment, and the small-diameter portion 2b may be provided at any position, such as an intermediate position of the insulated wire 2, depending on the type of additional member or the application of the wire harness.

Examples of the wire accommodation part of the additional member can include, in addition to a wire accommodation part in the form of a through hole such as the wire insertion hole 42 of the connector housing 4 in the above-described embodiment, a wire accommodation part having a groove structure with a U-shaped cross section along the axial direction of the insulated wire 2, and a wire accommodation part including a pair of plate-shaped members facing each other. When the wire accommodation part has a groove structure, the radius of curvature of the bottom of the cross section of the groove need only be larger than the radius of curvature of the small-diameter portion 2b of the insulated wire 2 and be smaller than the radius of curvature of the large-diameter portion 2a. For example, in the connector housing 4, a groove may be provided inside for positioning the insulated wire 2 connected to the connector terminal 5. When the wire accommodation part is constituted by a pair of plate-shaped members, the distance between the faces of these plate-shaped members need only be larger than the outer diameter Db of the small-diameter portion 2b of the insulated wire 2 and be smaller than the outer diameter Da of the large-diameter portion 2a. Examples of the additional member other than a connector include a fixing member for fixing and routing the wire 2 at a predetermined path.

Although the constituent material of the wire accommodation part is not limited, it is preferable that the material constituting the inner walls of the wire accommodation part be made of a hard material to the extent that the large-diameter portion 2a cannot be forcibly accommodated in the wire accommodation part with deformation of the inner walls. For example, it is preferable that the Young's modulus of the constituent material of the walls of the wire accommodation part be larger than the Young's modulus of the insulation coating 23 of the insulated wire 2. Polyester resins such as polybutylene phthalate (PBT) and polyamide resins such as 6-nylon (PA6), which are commonly used as materials of connector housings, are often harder than materials of insulation coatings of insulated wires and have large Young's moduli. In the wire harnesses of the present disclosure, these materials can also be suitably applied to the connector housing.

### [Details of Configuration of Insulated Wire]

The following will describe in detail a suitable configuration of the insulated wire 2 included in the wire harness according to the embodiment of the present disclosure. The insulated wire 2 includes the conductor 21 made of an elongated conductive material, and the insulation coating 23 that is made of an insulation material and covers the outer circumference of the conductor 21. The materials of the conductor 21 and the insulation coating 23 are not particularly limited.

Various metal materials can be used as the material of the conductor 21, and examples thereof include copper and copper alloys, aluminum and aluminum alloys, and the like. In particular, copper or copper alloys are preferably used in view of their high electrical conductivity and flexibility. The conductor 21 may be configured as a single wire, but may be preferably made of a plurality of bare wires 22 from the viewpoint of improving flexibility when bending, and the like. The plurality of bare wires 22 may constitute the conductor 21 in a bundle or may be twisted together into a twisted wire to form the conductor 21. The conductor 21 may be compression-molded, but the difference in outer diameter between the large-diameter portion 2a and the small-diameter portion 2b is easier to increase when the conductor 21 is not compression-molded.

The insulation coating 23 is made of a material containing an organic polymer. The type of organic polymer is not particularly limited, and can include olefinic polymers such as polyolefin and olefinic copolymers, halogenated polymers such as polyvinyl chloride, fluorinated polymers, various engineering plastics, elastomers, rubber, and the like. However, from the viewpoint of increasing the significance of achieving accommodation of the insulated wire 2 in the wire accommodation part of the additional member, such as the wire insertion hole 42 of the connector housing 4 by forming the small-diameter portion 2b on the insulated wire 2 rather than by deforming the insulation coating 23, the organic polymer constituting the insulation coating 23 is preferably made of a resin material with a relatively high modulus of elasticity and a resistance to deformation, such as an olefinic polymer, halogenated polymer, or fluorinated polymer, instead of elastomer or rubber. Also, from the viewpoint of facilitating the formation of the small-diameter portion 2b with heating, thermoplastic polymers are preferably used. The insulation coating 23 may contain, in addition to the organic polymer, additives as appropriate.

Although the specific dimensions of the insulated wire 2 are not particularly limited, the following dimensions can be suitably given as an example from the viewpoint of facilitating generation of a difference in outer diameter between the large-diameter portion 2a and the small-diameter portion 2b, and increasing the effect of generating a difference in outer diameter between the large-diameter portion 2a and the small-diameter portion 2b. In other words, as the cross-sectional area of the conductor, a range from 0.13 mm² to 200 mm² can be given as an example. As the outer diameter of the bare wires 22 constituting the conductor 21, a range from 0.1 mm to 1 mm can be given as an example. As the thickness (coating thickness) of the insulation coating 23, specifically, the thickness of the large-diameter portion 2a, a range from 0.2 mm to 2 mm can be given as an example. As the outer diameter of the insulated wire 2, specifically, the outer diameter Da of the large-diameter portion 2a, a range from 0.9 mm to 30 mm can be given as an example.

As described above, the insulated wire 2 has both the small-diameter portion 2b and the large-diameter portion 2a along its axial direction. The bare wires 22, which constitute the conductor 21, and the insulation coating 23 are continuously formed in one piece between the small-diameter portion 2b and the large-diameter portion 2a. The outer diameter Db of the small-diameter portion 2b is smaller than the outer diameter Da of the large-diameter portion 2a. Here, the outer diameters Db and Da of the small-diameter portion 2b and the large-diameter portion 2a are respectively the lengths of straight lines crossing the cross sections of the insulated wire 2 cut perpendicular to the axial direction, while passing through the center of gravity, in the small-diameter portion 2b and the large-diameter portion 2a. It is also possible to evaluate, in each cross section, the lengths of straight lines crossing the cross section in multiple directions, and define the average of the lengths of these multiple straight lines as the outer diameter. It is preferable that the small-diameter portion 2b and the large-diameter portion 2a each have a cross-sectional shape that can approximate a circular shape, and in this case, the diameters of the circular cross sections are the outer diameters Db and Da. In the shown form, the large-diameter portion 2a and the small-diameter portion 2b are mutually adjacent to each other along the axial direction of the insulated wire 2, with a transition portion 2c whose outer diameter changes gradually and that is arranged therebetween.

The specific difference between the outer diameter Db of the small-diameter portion 2b and the outer diameter Da of the large-diameter portion 2a is not particularly limited, but an outer diameter reduction ratio ((Da−Db)/Da×100%), which indicates the ratio of reduction of the outer diameter Db of the small-diameter portion 2b to the outer diameter Da of the large-diameter portion 2a, is preferably at least 3%. The outer diameter reduction ratio is more preferably at least 5%. This increases the significance of providing the small-diameter portion 2b in the insulated wire 2. Although the upper limit of the outer diameter reduction ratio is not specified, a range of approximately 10% or less can be used as an example of the outer diameter reduction ratio that can actually be set without difficulty.

The main factors that give rise to a difference between the outer diameter Db of the small-diameter portion 2b and the outer diameter Da of the large-diameter portion 2a may include the difference in the outer diameter of the conductor 21 between the small-diameter portion 2b and the large-diameter portion 2a, and the difference in the thickness of the insulating coating 23. If there can be a gap between the conductor 21 and the insulation coating 23, the difference in the size of the gap can also be included in the main factors. Preferably, at least one of the outer diameter of the conductor 21 and the thickness of the insulation coating 23 may be smaller in the small-diameter portion 2b than in the large-diameter portion 2a. With this, it is easier to generate a large difference in wire outer diameter between the small-diameter portion 2b and the large-diameter portion 2a. In particular, by making at least the thickness of the insulation coating 23 smaller in the small-diameter portion 2b than in the large-diameter portion 2a, it is easier to increase the difference in wire outer diameter between the small-diameter portion 2b and the large-diameter portion 2a. Furthermore, if both the outer diameter of the conductor 21 and the thickness of the insulation coating 23 are smaller in the small-diameter portion 2b than in the large-diameter portion 2a, the difference between the outer diameter Db of the small-diameter portion 2b and the outer diameter Da of the large-diameter portion 2a can be effectively increased. When the conductor 21 is made of the plurality of bare wires 22, the reduction in the outer diameter of the conductor 21 is achieved by at least one of reducing gaps between those bare wires 22 and deforming the bare wires 22. Of these approaches, reducing gaps between the plurality of bare wires 22 is more effective in reducing the outer diameter of the conductor 21.

From the viewpoint of facilitating the formation of a large difference between the outer diameter Db of the small-diameter portion 2b and the outer diameter Da of the large-diameter portion 2a, a coating thickness reduction ratio ((tₐ−t_{b})/tₐ×100%), which indicates the ratio of reduction of the thickness (t_{b}) of the insulation coating 23 in the small-diameter portion 2b to the thickness (tₐ) of the insulation coating 23 in the large-diameter portion 2a, is preferably at least 10%, and further preferably at least 15%. Although there is no particular upper limit for the coating thickness reduction ratio, a range of approximately 30% or less can be used as an example of the coating thickness reduction ratio that can actually be set without difficulty. From the same viewpoint, a conductor outer diameter reduction ratio ((dₐ−d_{b})/dₐ×100%), which indicates the ratio of reduction of the outer diameter (d_{b}) of the conductor 21 in the small-diameter portion 2b to the outer diameter (dₐ) of the conductor 21 in the large-diameter portion 2a, is preferably at least 1%, and further preferably at least 3%. Although there is no particular upper limit for the conductor outer diameter reduction ratio, a range of approximately 6% or less can be used as an example of the conductor outer diameter reduction ratio that can actually be set without difficulty.

Furthermore, it is preferable that the variation in the thickness of the insulation coating 23 is smaller in the small-diameter portion 2b than in the large-diameter portion 2a. If the variation in the thickness of the insulation coating 23 is smaller, the variation in the outer diameter of the insulated wire 2 in the small-diameter portion 2b will also be smaller. Accordingly, the dimensions of the wire accommodation part of the additional member that accommodates the small-diameter portion 2b, such as the wire insertion hole 42 of the connector housing 4, can be designed with a smaller margin taking into account the variations in the outer diameter of the insulated wire 2. In other words, it is possible to design the dimensions of the wire accommodation part and the entire additional member to be small.

For example, a variation (δ) in thickness of the insulation coating 23 in each of the small-diameter portion 2b and the large-diameter portion 2a can be evaluated (δ=(tₘₐₓ−tₘᵢₙ)/tₐᵥᵣ×100%), by measuring the thicknesses of the insulation coating 23 at a plurality of positions (e.g., four or more positions) along the circumferential direction in a cross section perpendicular to the axial direction, and obtaining the ratio of the difference between the maximum value (tₘₐₓ) and minimum value (tₘᵢₙ) of the thicknesses obtained at the plurality of positions to the average thickness (tₐᵥᵣ). As a coating thickness variation ratio (R_{δ}), the ratio of the thickness variation (δ_{b}) in the small-diameter portion 2b to the thickness variation (δₐ) in the large-diameter portion 2a is defined (R_{δ}=δ_{b}/δₐ), and the coating thickness variation ratio (R_{δ}) is preferably not more than 0.8. The coating thickness variation ratio (R_{δ}) is more preferably not more than 0.6. Also, the coating thickness variation (δ_{b}) in the small-diameter portion 2b is preferably not more than 40%, and more preferably not more than 30%. Although there is no particular lower limits for these values, a range of at least approximately 0.2 for the coating thickness variation ratio (R_{δ}) and a range of at least approximately 10% for the coating thickness variation (δ_{b}) in the small-diameter portion 2b can be used as examples of the ranges that can be actually achieved without difficulty. Furthermore, it is preferable that the smoothness of the surface of the insulation coating 23 be higher in the small-diameter portion 2b than in the large-diameter portion 2a.

In the insulated wire 2, the position and number of each of the small-diameter portion 2b and the large-diameter portion 2a along the axial direction are not particularly limited. The length of the region occupied by each of the small-diameter portion 2b and the large-diameter portion 2a is also not particularly limited. If a plurality of small-diameter portions 2b are formed, the outer diameters of these small-diameter portions 2b may be different or the same. Regarding the position of the small-diameter portion 2b, if, as shown in FIGS. 2A and 2B, a form is employed where the small-diameter portion 2b whose length along the axial direction is shorter than that of the large-diameter portion 2a is formed at an end portion of the insulated wire 2, the small-diameter portion 2b can be suitably used to attach the additional member such as the connector 3 to the end portion. The small-diameter portion 2b and the large-diameter portion 2a may be provided directly in a row along the axial direction of the insulated wire 2, or may be adjacent to each other with the transition portion 2c interposed therebetween. The central axis (a line passing through the center of gravity of the cross section and along the axial direction) of the small-diameter portion 2b and the central axis of the large-diameter portion 2a may coincide or may be misaligned, but it is preferable that they coincide, as in the form shown in the figures.

### [Insulated Wire Manufacturing Method]

The method of manufacturing the above-described insulated wire 2 having both the small-diameter portion 2b and the large-diameter portion 2a is not particularly limited. Examples of the manufacturing method include a method in which, when twisting together a plurality of bare wires 22 to form the conductor 21, regions with different filling densities of the bare wires 22 are provided along the axial direction, and a method in which, when performing extrusion molding to form the insulation coating 23 on the outer circumference of the conductor 21, the thicknesses of the insulation coating 23 are distributed by changing the amount of coating material to be extruded during the extrusion molding. However, particularly suitably, the method of forming the small-diameter portion 2b on a raw insulated wire having a uniform structure and dimension along the axial direction using press molding can be used. The following will briefly describe the manufacturing method.

As a raw insulated wire, an insulated wire having the same outer diameter Da (and conductor outer diameter and coating thickness) as that of the large-diameter portion 2a of the insulated wire 2 to be manufactured is prepared. The raw insulated wire can be manufactured by extruding and molding a coating material onto the outer circumference of the conductor 21, which is made of twisted bare wires 22. In this case, the outer diameter of the conductor and the thickness of the insulation coating 23 are defined as being uniform along the axial direction to the extent that they can be controlled. Conventional and typical insulated wires with a uniform cross section may be directly used as a raw twisted wire.

The small-diameter portion 2b is formed on the raw insulated wire obtained above. The small-diameter portion 2b can be formed by press molding. It is sufficient that a molding die having a cavity of the shape corresponding to the outer diameter Db and length of the desired small-diameter portion 2b be placed around the outer circumference of the raw insulated wire at the position where the small-diameter portion 2b is to be formed, and then the molding die is used to apply a force for compressing the raw insulated wire inward from the outer circumference to the raw insulated wire. At this time, by the application of the force, the outer diameter of the raw insulated wire is reduced, preferably accompanied by reductions in the conductor outer diameter and/or the coating thickness, thereby forming a small-diameter portion 2b.

Preferably, it is desirable that the raw insulated wire and/or the molding die be heated prior to the application of the force. Alternatively, or in addition, the application of the force may be performed while heating the molding die. By forming the small-diameter portion 2b with heating in these methods, the wire outer diameter can be effectively reduced together with a reduction in the thickness of the insulation coating 23. If the insulation coating 23 is made of a thermoplastic resin, it is sufficient that heating be performed so that the insulation coating 23 is at its softening temperature or higher. Note however that the heating temperature should be kept at the melting point of the insulation coating 23 or less. As the thickness of the insulation coating 23 is reduced by the press molding, the insulation coating 23 is stretched in the longitudinal direction of the insulated wire 2, and there can be a surplus in the length of the insulation coating 23. But the surplus insulation coating 23 need only be removed as needed by cutting it at its end, for example.

When forming the small-diameter portion 2b by press molding, the shape and dimensions of the outer circumferential surface of the small-diameter portion 2b are defined by the shape and dimensions of the cavity of the molding die. Therefore, even if there is some variation in the dimensions and shape of the raw insulated wire before press molding between positions, the variation in the dimensions and shape can be reduced in the small-diameter portion 2b obtained through the press molding. The thicknesses of polymer material layers formed by extrusion molding are likely to vary, but the variation in thickness can be reduced by press molding. Therefore, compared to the large-diameter portion 2a, which inherits the state of the insulation coating 23 formed by extrusion molding during the manufacturing of the raw insulated wire, the small-diameter portion 2b, which has undergone press molding, is more likely to have a smaller variation in the thickness of the insulation coating 23 along the circumferential direction and axial direction of the insulated wire 2. Furthermore, if the small-diameter portion 2b is formed by press molding with heating as described above, it is easy to improve the smoothness of the surface of the insulation coating 23 in the small-diameter portion 2b by using the softening of the insulation coating 23.

### Examples

Examples are given below. The present invention is not limited to these examples. Here, it was confirmed based on model samples that insulated wires each having a small-diameter portion and a large-diameter portion can actually be fabricated, and that the fabricated insulated wires can be attached to connectors using the small-diameter portions. Unless otherwise noted, the fabrication and evaluation of the samples were conducted at room temperature and in the air.

### <Fabrication of Samples>

As a raw insulated wire, an insulated wire was made by extruding and molding an insulation coating of a uniform thickness around the outer circumference of a conductor. A bundle of 1924 bare wires that are made of a copper alloy and have an outer diameter of 0.3 mm was used as the conductor, and cross-linked polyethylene was used as the constituent material of the insulation coating.

The above-described raw insulated wire was cut to 200 mm in length, and a small-diameter portion was formed in a region of 100 mm from the end to obtain the insulated wire to be used as a sample. The remaining region was used without modification as a large-diameter portion. The formation of the small-diameter portion was performed by press molding using a die with a cylindrical cavity. The temperature of the die was 150° C.

### <Evaluation of Samples>

The obtained insulated wire was cut in cross sections perpendicular to the axial direction at the large-diameter and small-diameter portions to obtain transverse cross section samples. In each of the transverse cross section samples, the outer diameter of the insulated wire as a whole (wire outer diameter), the outer diameter of the conductor (conductor outer diameter), and the thickness of the insulation coating (coating thickness) were measured. The measurement of the dimensions were performed on the obtained transverse cross section along straight lines in four directions set at 45° intervals with respect to the center of gravity, and the values measured in those four directions were averaged. The variation of the values was also calculated as the quotient obtained by dividing the difference between the maximum and minimum values of the measured values by the average.

As a model of the connector housing, a flat plate made of polybutylene terephthalate with a circular through hole of an inner diameter of 17.2 mm was prepared. The insulated wire fabricated in the above-described manner was inserted into the through hole in this plate from the small-diameter side, and the resultant was defined as a model sample. This model sample was cut along the axial direction of the insulated wire to obtain a sample longitudinal cross section, and the condition of the cross section was observed.

### <Evaluation Results>

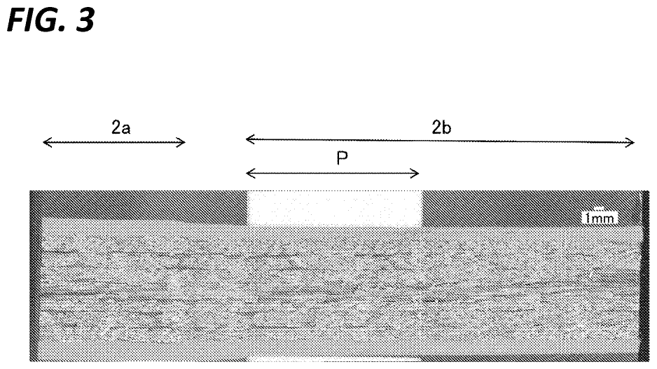

The measurement results of the wire outer diameters, the conductor outer diameter, and the coating thickness of the small-diameter and large-diameter portions are summarized in Table 1 below. The table indicates the measured values (#1 to #4 for wire outer diameters and conductor outer diameters and #1 to #8 for insulation thickness) obtained from the four-direction measurements, their averages, and their variation values. In addition, for the averages, the decrease amount and reduction ratio of the value of the small-diameter portion to the value of the large-diameter portion are also indicated. Also, FIG. 3 shows a photographed picture of the sample longitudinal cross section obtained by cutting the model sample.

TABLE 1

| | | Large-diameter | Small-diameter |
|---|---|---|---|
| | | portion [mm] | portion [mm] |
| Wire outer | #1 (mm) | 18.8 | 16.7 |
| diameter | #2 (mm) | 17.6 | 16.7 |
| | #3 (mm) | 17.2 | 16.5 |
| | #4 (mm) | 17.8 | 16.6 |
| | Average (mm) | 17.8 | 16.6 |
| | Variation | 9% | 2% |
| | Decrease amount (mm) | — | 1.2 |
| | Reduction ratio | — | 7% |
| Conductor | #1 (mm) | 14.3 | 13.6 |
| outer | #2 (mm) | 14.5 | 13.8 |
| diameter | #3 (mm) | 14.2 | 13.9 |
| | #4 (mm) | 14.2 | 13.6 |
| | Average (mm) | 14.3 | 13.7 |
| | Variation | 2% | 2% |
| | Decrease amount (mm) | — | 0.6 |
| | Reduction ratio | — | 4% |
| Coating | #1 (mm) | 2.1 | 1.5 |
| thickness | #2 (mm) | 1.4 | 1.4 |
| | #3 (mm) | 1.3 | 1.3 |
| | #4 (mm) | 2.0 | 1.6 |
| | #5 (mm) | 2.3 | 1.6 |
| | #6 (mm) | 1.6 | 1.5 |
| | #7 (mm) | 1.5 | 1.3 |
| | #8 (mm) | 1.5 | 1.3 |
| | Average (mm) | 1.7 | 1.4 |
| | Variation | 50% | 24% |
| | Decrease amount (mm) | — | 0.3 |
| | Reduction ratio | — | 16% |

According to Table 1, the wire outer diameter is 1.2 mm smaller in the small-diameter portion than in the large-diameter portion in terms of average. Even with reference to the picture of the longitudinal cross section in FIG. 3, it is apparent that the outer diameter (outer dimension in the vertical direction) is smaller in the small-diameter portion indicated by the reference sign 2b than in the large-diameter portion indicated by the reference sign 2a. Based on that fact, it is confirmed that the small-diameter portion whose outer diameter was reduced relative to the original value could be formed through press molding.

Then, as shown in the picture in FIG. 3, the small-diameter portion was able to pass through the through hole in the plate indicated by the reference sign P (area photographed in white) without being deformed, but the large diameter-portion was not able to enter the through hole. The inner diameter of the through hole is 17.2 mm, which is smaller than 17.8 mm of the outer diameter of the large-diameter portion but is larger than 16.6 mm of the outer diameter of the small-diameter portion (both in terms of average). Due to the relationship between the inner diameter of the through hole and the wire outer diameter, only the small-diameter portion of the insulated wire can pass through the through hole. In other words, it is apparent that by designing the wire accommodation part of the additional member, such as the wire insertion hole in the form of a through hole, with dimensions that do not allow the large-diameter portion of the insulated wire to be accommodated but allow the small-diameter portion to be accommodated, the additional member can be attached to the insulated wire with the small-diameter portion being accommodated in the wire accommodation part.

Furthermore, according to Table 1, the conductor outer diameter is 0.6 mm smaller and the coating thickness is 0.3 mm smaller in the small-diameter portion than in the large-diameter portion both in terms of average. In other words, it is confirmed that the above-described 1.2 mm decrease in wire outer diameter consists of a 0.6 mm decrease in conductor outer diameter and a 0.3 mm decrease on each side of the diameter, that is, a 0.6 mm decrease in coating thickness on both sides. While the reduction ratio of conductor outer diameter is 4%, the reduction ratio of coating thickness is 16%, meaning that, in particular, the decrease in thickness of the insulation coating significantly contributes to the decrease in wire outer diameter in the small-diameter portion. Also, in the picture of the longitudinal cross section in FIG. 3, it can be seen that both the decrease in the outer diameter of the wire conductor and the decrease in the thickness of the insulation coating have occurred in the small-diameter portion, compared to in the large-diameter portion. In addition, the areas of gaps between the darkly photographed bare wires inside the wire conductor are smaller in the small-diameter portion than in the large-diameter portion, indicating that the reduction in the outer diameter of the wire conductor has occurred together with reductions in the gaps between the bare wires.

In Table 1, when focusing on the variation in coating thickness (the above-described δ), it is 50% in the large-diameter portion and 24% in the small-diameter portion, meaning that the variation is reduced to half or less (the above-described R_{δ} is 0.50 or less). In other words, it is confirmed that the variation in coating thickness has decreased when the small-diameter portion was formed by press molding. Along with this decrease in variation in coating thickness, the variation in wire outer diameter has also decreased from 9% in the large-diameter portion to 2% in the small-diameter portion, which is a reduction of one-fourth or less.

Although the embodiment of the present disclosure has been described in detail so far, the present invention is not limited in any way to the embodiment above, and various modifications are possible without departing from the gist of the invention.

The above-described insulated wire constituting the wire harness according to the embodiment of the present disclosure is also applicable to, in addition to the usage of serving as an insulated wire having a portion with a smaller outer diameter, while minimizing the effect on the characteristics of the insulated wire to constitute various types of wire harnesses, usages other than the usage of constituting a wire harness. In other words, when the object is to provide an insulated electric wire having a portion with a smaller outer diameter while minimizing the effect on the characteristics of the insulated wire, an insulated wire having the following configuration can be suitably presented.

[1′] An insulated wire includes a conductor and an insulation coating that covers an outer circumference of the conductor, and has a large-diameter portion and a small-diameter portion along an axial direction, the small-diameter portion having an outer diameter smaller than an outer diameter of the large-diameter portion.

[2′] In the mode according to [1′] above, preferably, the insulated wire has the small-diameter portion at its end portion in the axial direction.

[3′] In the mode according to [1′] or [2′] above, preferably, at least one of an outer diameter of the conductor and a thickness of the insulation coating is smaller in the small-diameter portion than in the large-diameter portion.

[4′] In the mode according to [3′] above, preferably, both the outer diameter of the conductor and the thickness of the insulation coating are smaller in the small-diameter portion than in the large-diameter portion.

[5′] In the mode according to any one of [1′] to [4′] above, preferably, the outer diameter of the small-diameter portion is at least 3% smaller than the outer diameter of the large-diameter portion.

[6′] In the mode according to any one of [1′] to [5′] above, preferably, a thickness of the insulation coating in the small-diameter portion is at least 10% smaller than a thickness of the insulation coating in the large-diameter portion.

[7′] In the mode according to any one of [1′] to [6′] above, preferably, a variation in thickness of the insulation coating is smaller in the small-diameter portion than in the large-diameter portion.

### LIST OF REFERENCE NUMERALS

1 Wire harness
2 Insulated wire
21 Conductor
22 Bare wire
23 Insulation coating
2a Large-diameter portion
2b Small-diameter portion
2c Transition portion
3 Connector (additional member)
4 Connector housing
41 Rear end wall
42 Wire insertion hole (wire accommodation part)
43 Mating port
5 Connector terminal
51 Connection
52 First clamping portion
53 Second clamping portion
Da Outer diameter of large-diameter portion
Db Outer diameter of small-diameter portion
Dh Inner diameter of wire insertion hole

1. A wire harness comprising:
an insulated wire including a conductor and an insulation coating that covers an outer circumference of the conductor; and
an additional member including a wire accommodation part,
wherein the insulated wire has a large-diameter portion and a small-diameter portion along an axial direction, the small-diameter portion having an outer diameter smaller than an outer diameter of the large-diameter portion,
the insulation coating is continuous from the small-diameter portion to the large-diameter portion throughout its entire thickness direction,
the insulation coating is configured as a layer that is in direct contact with the conductor in both the small-diameter portion and the large-diameter portion, the layer that is in direct contact with the conductor having an outer diameter, serving as a wire outer diameter, that is smaller in the small-diameter portion than in the large-diameter portion,
the wire accommodation part of the additional member is not capable of accommodating the large-diameter portion but is capable of accommodating the small-diameter portion, and is formed as a through hole having an inner diameter that is larger than the outer diameter of the small-diameter portion of the insulated wire and smaller than the outer diameter of the large-diameter portion,
the small-diameter portion can be inserted into and passed through the through hole serving as the wire accommodation part from outside the additional member, without being deformed,
the additional member is attached to the insulated wire with the small-diameter portion of the insulated wire being accommodated in the wire accommodation part, and
the small-diameter portion of the insulated wire is inserted into the wire accommodation part.

2. The wire harness according to claim 1,
wherein the insulated wire has the small-diameter portion at its end portion in the axial direction, and
the additional member is a connector.

3. The wire harness according to claim 1,
wherein at least one of an outer diameter of the conductor and a thickness of the insulation coating is smaller in the small-diameter portion than in the large-diameter portion, the thickness of the insulation coating being the thickness of the insulation coating configured as the layer that is in direct contact with the conductor.

4. The wire harness according to claim 3,
wherein both the outer diameter of the conductor and the thickness of the insulation coating are smaller in the small-diameter portion than in the large-diameter portion.

5. The wire harness according to claim 1,
wherein the outer diameter of the small-diameter portion is at least 3% smaller than the outer diameter of the large-diameter portion.

6. The wire harness according to claim 1,
wherein a thickness of the insulation coating in the small-diameter portion is at least 10% smaller than a thickness of the insulation coating in the large-diameter portion.

7. The wire harness according to claim 1,
wherein a variation in thickness of the insulation coating is smaller in the small-diameter portion than in the large-diameter portion.

8. The wire harness according to claim 1,
wherein a variation in thickness of the insulation coating is smaller and a surface smoothness of the insulation coating is higher in the small-diameter portion than in the large-diameter portion.

9. The wire harness according to claim 1,
wherein the small-diameter portion is formed by applying a force to a raw insulated wire uniformly in the axial direction to compress the raw insulated wire inward from its outer circumference, the raw insulated wire being configured as an insulated wire that has the same dimensions as an outer diameter of the conductor and a thickness of the insulation coating in the large-diameter portion.

10. (canceled)
